(19) United States
(12) Patent Application Publication
(10) Pub. No.: US 2026/0352996 A1
(43) Pub. Date: Nov. 5, 2026

(54) Speaker Box

(71) Applicant: AAC Microtech (Changzhou) Co., Ltd., Changzhou City (CN)

(72) Inventors: Jinming Li, Changzhou (CN); Wei Wei, Changzhou (CN); Zhizhu Chen, Changzhou (CN); Huhu Yang, Changzhou (CN)

(21) Appl. No.: 19/304,646

(22) Filed: Aug. 20, 2025

Related U.S. Application Data
(63) Continuation of application No. PCT/CN2025/092396, filed on Apr. 30, 2025.

(51) Int. Cl. H04R 1/28; H04R 1/02; H04R 1/06; H04R 7/04; H04R 7/18; H04R 9/02; H04R 9/06

(52) U.S. Cl. CPC H04R 1/2811; H04R 1/025; H04R 1/06; H04R 7/04; H04R 7/18; H04R 9/025; H04R 9/06; H04R 2400/11

(57) ABSTRACT

The present invention provides a speaker box including a housing and a speaker mounted on a side of the housing. The speaker includes a frame, a diaphragm and a magnetic circuit system supported on the frame respectively, and a voice coil driving the diaphragm to vibrate and generate sounds. The housing is located on a side of the magnetic circuit system away from the diaphragm. The diaphragm, the frame, the magnetic circuit system, and the housing cooperate to form a closed rear acoustic chamber. The speaker box of the present invention can achieve larger dimensions in both the length and width directions, and effectively improve the acoustic performance of the speaker box.

### FIELD OF THE PRESENT INVENTION

The present invention relates to the field of electro-acoustic conversion, and more particularly, to a speaker box.

### DESCRIPTION OF RELATED ART

Speaker boxes are commonly used sound generating devices in electronic devices. A speaker box typically includes a housing structure and a sound generating portion received in the housing structure. In related art, the speaker box includes an upper cover, a lower cover cooperated with the upper cover to form a receiving space, and a speaker located in the receiving space. The speaker of this type of speaker box is completely contained in the receiving space enclosed by the upper and lower covers. The upper cover is provided with a sound hole for sound emission, which allows a certain amount of space in the length and width directions of the speaker box to be occupied by the cover. This makes it difficult to achieve optimal acoustic performance for speaker box that need to be limited to a certain size.

Therefore, it is desired to provide a new speaker box which can overcome the above problems.

### SUMMARY

In view of the above, the embodiments of the present invention provide a new speaker box. By the present invention, the speaker box can achieve optimal acoustic performance when limited to a certain size.

The present invention provides a speaker box including a housing and a speaker mounted on a side of the housing. The speaker includes a frame, a diaphragm and a magnetic circuit system supported on the frame respectively, and a voice coil driving the diaphragm to vibrate and generate sounds. The housing is located on a side of the magnetic circuit system away from the diaphragm. The diaphragm, the frame, the magnetic circuit system, and the housing cooperate to form a closed rear acoustic chamber.

As an improvement, the magnetic circuit system includes a magnetic yoke, a main magnet and an auxiliary magnet fixed to the magnetic yoke, the auxiliary magnet arranged around the main magnet and forming a magnetic gap with the main magnet, the auxiliary magnet having an annular shape, the diaphragm, the frame, the auxiliary magnet, the magnetic yoke, and the housing cooperated to form the closed rear acoustic chamber.

As an improvement, an interior of the speaker is provided with a sound chamber, the housing enclosed to form a containment chamber, the magnetic yoke provided with at least one communication hole, the sound chamber communicated with the containment chamber through the communication hole and forming the closed rear acoustic chamber.

As an improvement, a number of the communication holes is four, and the magnetic yoke has a rectangular shape, each communication hole extending from a short axis of the magnetic yoke to a long axis of the magnetic yoke.

As an improvement, a position of the communication hole corresponds to a position of the magnetic gap.

As an improvement, the speaker further includes an inserting member penetrating the magnetic circuit system, a pair of conductive terminals located in the inserting member, and a circuit board fixed to the inserting member and electrically connected to the conductive terminals, the voice coil including a pair of leading wires, the circuit board electrically connected to the leading wires.

As an improvement, the circuit board includes a fixed portion fixed to the conductive terminals, an elastic portion bending and extending from both sides of the fixed portion, and a soldering portion connected to each elastic portion, the leading wires soldered and fixed to the soldering portions.

As an improvement, the elastic portion includes a first connection portion extending horizontally and a second connection portion bending and extending from the first connection portion along a vibration direction of the diaphragm, the fixed portion connected to the first connection portion, and the soldering portion connected to the second connection portion.

As an improvement, the magnetic circuit system further includes a first pole plate stacked on the main magnet and a second pole plate stacked on the auxiliary magnet, the inserting member penetrating the magnetic yoke, the main magnet, and the first pole plate.

As an improvement, a portion of the voice coil corresponding to the second pole plate is provided with a recessing portion.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a speaker box in accordance with one embodiment of the present invention.

FIG. 2 is a partially exploded view of the speaker box of FIG. 1.

FIG. 3 is an exploded view of the speaker box of FIG. 1.

FIG. 4 is an illustrative cross-sectional view of the speaker box taken along line A-A of FIG. 1.

FIG. 5 is an illustrative cross-sectional view of the speaker box taken along line B-B of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

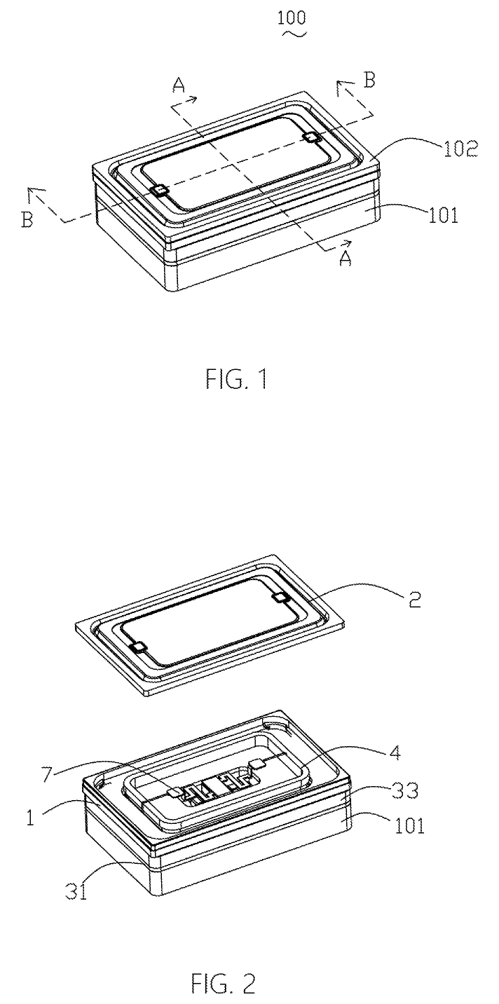

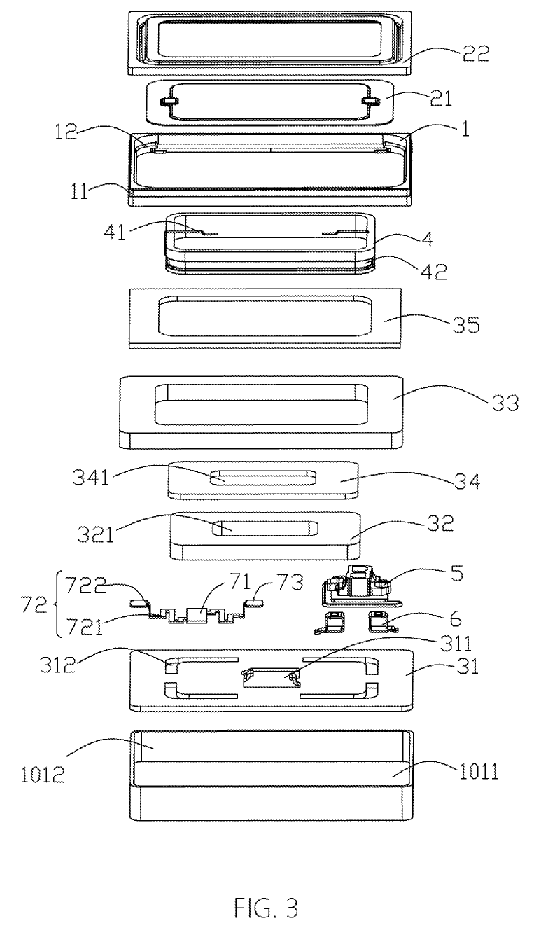

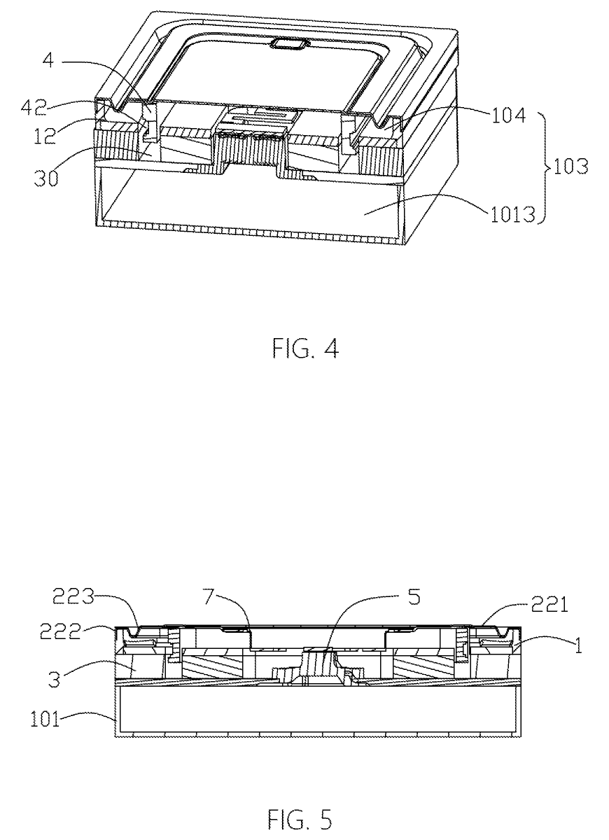

Referring to the FIGS. 1-5, the present invention provides one embodiment of a speaker box 100. The speaker box 100 includes a housing 101 and a speaker 102 mounted on a side of the housing 101.

The housing 101 includes a bottom wall 1011 and a side wall 1012 formed by bending from an edge of the bottom wall 1011. The bottom wall 1011 and the side wall 1012 cooperate to enclose a containment chamber 1013.

The speaker 102 has a rectangular shape. The speaker 102 includes a frame 1, a diaphragm 2 and a magnetic circuit system 3 supported on the frame 1 respectively, a voice coil 4 driving the diaphragm 2 to vibrate and generate sounds, an inserting member 5 penetrating the magnetic circuit system 3, a pair of conductive terminals 6 located in the inserting member 5, and a circuit board 7 fixed to the inserting member 5 and electrically connected to the conductive terminals 6. The housing 101 locates on a side of the magnetic circuit system 3 away from the diaphragm 2. The diaphragm 2, the frame 1, the magnetic circuit system 3, and the housing 101 cooperate to form a closed rear acoustic chamber 103. An interior of the speaker 102 is provided with a sound chamber 104. The sound chamber 104 cooperates with the containment chamber 1013 of the housing 101 to enclose the closed rear acoustic chamber 103.

The frame 1 is a circular structure, and a portion of an upper surface of the frame 1 recesses to form a receiving portion 11. An inner surface of the frame 1 is formed with a clamping portion 12.

The diaphragm 2 includes a dome 21 and a suspension 22 surrounding the dome 211. The suspension 22 includes an inner fixing portion 221 fixed to the dome 21, an outer fixing portion 222 fixed to the frame 1, and a suspension portion 223 connecting the inner fixing portion 221 and the outer fixing portion 222. The outer fixing portion 222 covers the upper surface of the frame 1 and bends and extends into the receiving portion 11 of the frame 1.

The magnetic circuit system 3 includes a magnetic yoke 31, a main magnet 32 fixed to the magnetic yoke 31, and an auxiliary magnet 33 arranged around the main magnet 32, a first pole plate 34 stacked on the main magnet 32 and a second pole plate 35 stacked on the auxiliary magnet 33. The auxiliary magnet 33 is spaced apart from the main magnet 32 to form a magnetic gap 30.

The magnetic yoke 31 has a rectangular plate shape. The magnetic yoke 31 includes a first through hole 311 disposed in a middle position of the magnetic yoke 31 and at least one communication hole 312. A position of the communication hole 312 corresponds to a position of the magnetic gap 30. That is, the communication hole 312 is aligned with the magnetic gap 30 and is communicated with the magnetic gap 30. The sound chamber 104 is communicated with the containment chamber 1013 through the communication hole 312 and form the closed rear acoustic chamber 103. In this embodiment, a number of the communication holes 312 is four, and each communication hole 312 extends from a short axis of the magnetic yoke 31 to a long axis of the magnetic yoke 31.

The main magnet 32 is provided with a second through hole 321 to make the main magnet 32 has a ring-shaped structure. The first pole plate 34 is provided with a third through hole 341 to make the first pole plate 34 also has a ring-shaped structure. The first through hole 311, the second through hole 321, and the third through hole 341 are arranged aligned. The auxiliary magnet 33 has an annular shape. The second pole plate 35 also has an annular shape, and the second pole plate 35 is fixed with the clamping portion 12 of the frame 1. Specifically, the frame 1 can be molded to cover a portion of the second plate 35. The auxiliary magnet 33 is sandwiched between the frame 1 and the magnetic yoke 31 to make an outer peripheral side of the speaker 102 form a sealed structure. Specifically, the diaphragm 2, the frame 1, the auxiliary magnet 33, the magnetic yoke 31, and the housing 101 cooperate to form the closed rear acoustic chamber 103.

The voice coil 4 includes a pair of leading wires 41. The leading wires 41 are led out from the surface of the voice coil 4 proximal to the diaphragm 2 and are electrically connected to the circuit board 7. A portion of the voice coil 4 corresponding to the second pole plate 35 is provided with a recessing portion 42.

The inserting member 5 penetrates the magnetic yoke 31, the main magnet 32, and the first pole plate 34. That is, the inserting member 5 locates in the first through hole 311, the second through hole 321, and the third through hole 341. The conductive terminals 6 are a pair, and the pair of conductive terminals 6 are embedded in the inserting member 5 and partially exposed on the upper surface of the inserting member 5 to connect to the circuit board 7.

The circuit board 7 includes a fixed portion 71 fixed to the conductive terminals 6, an elastic portion 72 bending and extending from both sides of the fixed portion 71, and a soldering portion 73 connected to each elastic portion 72. The leading wires 41 are soldered and fixed to the corresponding soldering portions 73. The fixed portion 71 is electrically connected to the conductive terminals 6. The elastic portion 72 includes a first connection portion 721 extending horizontally and a second connection portion 722 bending and extending from the first connection portion 721 along a vibration direction of the diaphragm 2. The fixed portion 71 is connected to the first connection portion 721, and the soldering portion 73 is connected to the second connection portion 722.

Comparing with the related art, the present invention provides a speaker box including a housing and a speaker mounted on a side of the housing. The speaker includes a frame, a diaphragm and a magnetic circuit system supported on the frame respectively, and a voice coil driving the diaphragm to vibrate and generate sounds. The housing is located on a side of the magnetic circuit system away from the diaphragm. The diaphragm, the frame, the magnetic circuit system, and the housing cooperate to form a closed rear acoustic chamber. A side of the speaker of the present invention directly forms a closed structure, and the housing is only covered on the rear side of the speaker. The housing does not occupy the space in the length and width space of the speaker, which effectively improving the acoustic performance of the speaker box in a certain small-sized environment.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker box, comprising:
a housing; and
a speaker mounted on a side of the housing, the speaker comprising:
a frame;
a diaphragm supported on the frame;
a magnetic circuit system supported on the frame; and
a voice coil driving the diaphragm to vibrate and generate sounds;
wherein the housing is located on a side of the magnetic circuit system away from the diaphragm, the diaphragm, the frame, the magnetic circuit system, and the housing cooperated to form a closed rear acoustic chamber.

2. The speaker box as described in claim 1, wherein the magnetic circuit system comprises a magnetic yoke, a main magnet and an auxiliary magnet fixed to the magnetic yoke, the auxiliary magnet arranged around the main magnet and forming a magnetic gap with the main magnet, the auxiliary magnet having an annular shape, the diaphragm, the frame, the auxiliary magnet, the magnetic yoke, and the housing cooperated to form the closed rear acoustic chamber.

3. The speaker box as described in claim 2, wherein an interior of the speaker is provided with a sound chamber, the housing enclosed to form a containment chamber, the magnetic yoke provided with at least one communication hole, the sound chamber communicated with the containment chamber through the communication hole and forming the closed rear acoustic chamber.

4. The speaker box as described in claim 3, wherein a number of the communication holes is four, and the magnetic yoke has a rectangular shape, each communication hole extending from a short axis of the magnetic yoke to a long axis of the magnetic yoke.

5. The speaker box as described in claim 3, wherein a position of the communication hole corresponds to a position of the magnetic gap.

6. The speaker box as described in claim 3, wherein the speaker further comprises an inserting member penetrating the magnetic circuit system, a pair of conductive terminals located in the inserting member, and a circuit board fixed to the inserting member and electrically connected to the conductive terminals, the voice coil comprising a pair of leading wires, the circuit board electrically connected to the leading wires.

7. The speaker box as described in claim 6, wherein the circuit board comprises a fixed portion fixed to the conductive terminals, an elastic portion bending and extending from both sides of the fixed portion, and a soldering portion connected to each elastic portion, the leading wires soldered and fixed to the soldering portions.

8. The speaker box as described in claim 7, wherein the elastic portion comprises a first connection portion extending horizontally and a second connection portion bending and extending from the first connection portion along a vibration direction of the diaphragm, the fixed portion connected to the first connection portion, and the soldering portion connected to the second connection portion.

9. The speaker box as described in claim 6, wherein the magnetic circuit system further comprises a first pole plate stacked on the main magnet and a second pole plate stacked on the auxiliary magnet, the inserting member penetrating the magnetic yoke, the main magnet, and the first pole plate.

10. The speaker box as described in claim 9, wherein a portion of the voice coil corresponding to the second pole plate is provided with a recessing portion.
